(19) United States
(12) Patent Application Publication
(10) Pub. No.: US 2009/0278018 A1
(43) Pub. Date: Nov. 12, 2009

(54) LIFTING DEVICE OF A DISPLAY APPARATUS

(75) Inventors: Jae Hoo PARK, Suwon-si (KR); Boo Keun Yoon, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/437,862

(22) Filed: May 8, 2009

(30) Foreign Application Priority Data
May 8, 2008 (KR) 2008-43077

(51) Int. Cl. A47G 1/24; F16M 13/02; A47F 7/00; A47G 1/16

(52) U.S. Cl. 248/492; 248/493; 248/328; 248/329; 248/324; 248/330.1

(57) ABSTRACT

A lifting device of a display apparatus to allow for an upward/downward movement of the display apparatus and to improve a utility in installation space. The lifting device includes at least one wire coupled to the display apparatus, a lifting unit connected to the wire to move the display apparatus in a first direction or a second direction using a first force acting on the display apparatus. The lifting unit includes a position retainer to apply a second force counter to a weight of the display apparatus in order to maintain the display apparatus at a position, if the first force is removed.

### CROSS-REFERENCE TO RELATED APPLICATIONS

This application claims priority under 35 U.S.C. § 119(a) from Korean Patent Application No. 2008-0043077, filed on May 8, 2008 in the Korean Intellectual Property Office, the disclosure of which is incorporated herein in its entirety by reference.

### BACKGROUND

1. Field of the Invention

The general inventive concept relates to a lifting device of a display apparatus, and, more particularly, to a lifting device of a display apparatus to allow an upward/downward movement of the display apparatus.

2. Description of the Related Art

A display apparatus is one type of screen output apparatus, such as televisions, computer monitors, etc., and is currently used in homes, offices, and the like. In recent years, a flat display apparatus having a thin thickness and a small volume, such as a Liquid Crystal Display (LCD), Plasma Display Panel (PDP), etc., has been developed and has been widely used. Thus, a demand therefor is gradually increasing.

Such a flat display apparatus having a thin thickness allows for more effective space utilization when mounted to a wall and thus, exhibits convenience of use. For this reason, a variety of supporting devices which are used to mount a display apparatus to a wall have been developed.

As one example, Korean Patent Laid-Open Publication No. 2005-0073654 (hereinafter, “′654”) discloses a supporting device to mount a display apparatus to a wall. The supporting device, disclosed in the '654 publication includes a body bracket to support a body of the display apparatus, a fixing bracket attached to a target wall, and refractive link assemblies rotatably connected between the fixing bracket and the body bracket. As the link assemblies are refracted and rotated, the supporting device can adjust a tilting of the display apparatus.

Another example of a supporting device for a display apparatus is disclosed in Japanese Patent Laid-Open Publication No. 2002-006771 (hereinafter “′771”).

The '771 publication discloses a supporting device to move a display apparatus in an upward or downward direction using a wire.

One problem with the supporting device disclosed in the '654 publication is that the supporting device is constructed of a large number of elements, thus increasing manufacturing costs associated therewith. Furthermore, due to a complicated configuration of the supporting device, a user has difficulty in installing the supporting device and therefore additional installation time is required.

Another problem is that a display apparatus, mounted using the above supporting device, protrudes from the wall by a considerable length, thereby resulting in a low space utilization.

As a further problem, the display apparatus is supported on the wall while being fixed to the wall and thus, the display apparatus has difficulty moving in an upward/downward direction.

In the case of the supporting device disclosed in the '771 publication, it does not disclose a detailed configuration of a reverse-rotation obstructer to maintain a heavy display apparatus at a fixed position on a ceiling using a wire.

To manually move the display apparatus in an upward or downward direction, it is necessary to roll up an end of the wire mounted to the ceiling or the wall, which causes inconvenience.

### SUMMARY

The general inventive concept provides a lifting device of a display apparatus which can move the display apparatus upward or downward and can achieve an improved utility in installation space.

Additional features and/or utilities of the present general inventive concept will be set forth in part in the description which follows and, in part, will be obvious from the description, or may be learned by practice of the general inventive concept.

Exemplary embodiments of the present general inventive concept provide a lifting device of a display apparatus which can achieve an effective upward/downward movement of the display apparatus with an improved convenience of use.

Exemplary embodiments of the present general inventive concept also provide a lifting device of a display apparatus which can achieve simultaneous upward/downward movement and tilting of the display apparatus.

Exemplary embodiments of the present general inventive concept also provide a lifting device of a display apparatus including: at least one wire coupled to the display apparatus and a lifting unit coupled to the at least one wire to move the display apparatus in a first direction or a second direction using a first force acting on the display apparatus, wherein the lifting unit includes a position retainer to apply a second force counter to a weight of the display apparatus to the wire in order to maintain the display apparatus at a position, if the first force is removed.

The at least one wire may have a first end connected to the lifting unit and a second end connected to a surface of the display apparatus.

The lifting unit may be configured to support the weight of the display apparatus and to guide the at least one wire.

The lifting device may further include a roller configured to support the weight of the display apparatus and to guide the at least one wire.

The lifting unit may be coupled to the display apparatus, and the at least one wire may have a first end fixed to a position above the lifting unit and a second end coupled to the lifting unit.

The lifting device may further include a first wheel coupled to a first portion of the display apparatus to allow a lower portion of the display apparatus to be supported on a wall.

The lifting unit may include at least one rotating drum on which the at least one wire is wound.

The position retainer may include an elastic member to counter to the weight of the display apparatus.

The lifting unit may further include a bearing provided between the rotating drum and the display apparatus to guide the at least one wire.

The rotating drum may define a receiving room in which the position retainer may be received, and a rail about which the at least one wire is wound.

The lifting device may further include a tilting unit coupled to the display apparatus to tilt the display apparatus.

The tilting unit may include a drive motor, an arm coupled to the drive motor so as to be rotated about a rotating shaft of the drive motor, and a second wheel provided at one end of the arm.

Exemplary embodiments of the present general inventive concept also provide a lifting device of a display apparatus including: at least one wire connected to the display apparatus, a rotating drum to rotate to allow the at least one wire to be wound or unwound on or from the rotating drum according to a first or second directional movement of the display apparatus, and a position retainer to apply a force counter to a weight of the display apparatus to the rotating drum so as to maintain the display apparatus at a position when no external force is applied.

The position retainer may include a spiral spring provided in the rotating drum.

A rotatable arm may be provided at a surface of the display apparatus to tilt the display apparatus.

The lifting device may further include a fixing bracket to receive the rotating drum and the position retainer.

Exemplary embodiments of the present general inventive concept also provide a lifting device of a display apparatus including at least one rotating drum mounted on one of the display apparatus and a fixed surface to which the display apparatus is attached, a wire having one end connected to the at least one rotating drum and the other end connected to the other one of the display apparatus and the fixed surface to which the display apparatus is attached, and a position retainer to apply a force counter to a weight of the display apparatus to the at least one rotating drum along an upward or downward movement direction of the display apparatus.

The lifting device may further include a rotating shaft to rotatably mount the at least one rotating drum on the one of the display apparatus and the fixed surface to which the display apparatus is attached.

The position retainer may include a spiral spring having one end fixed to the at least one rotating drum and the other end fixed to the rotating shaft.

The lifting device may further include a fixing bracket to rotatably mount the at least one rotating drum on the fixed surface.

The lifting device may further include a fixing bracket to rotatably mount the at least one rotating drum on a rear surface of the display apparatus.

The lifting device may further include a roller mounted on the fixed surface to convert a movement direction of the wire.

The at least one rotating drum may include a rail on or from which the wire is wound or unwound according to a first or second directional movement of the display apparatus.

The lifting device may further include a wheel coupled to a rear surface of the display apparatus to allow a lower portion of the display apparatus to be supported on the fixed surface.

### BRIEF DESCRIPTION OF THE DRAWINGS

These and/or other features and utilities of the exemplary embodiments of the present general inventive concept will become apparent and more readily appreciated from the following description of the exemplary embodiments, taken in conjunction with the accompanying drawings of which:

FIG. 1 is a perspective view illustrating an overall outer appearance of a lifting device of a display apparatus according to an exemplary embodiment of the present general inventive concept;

FIG. 2 is an exploded perspective view illustrating components of a lifting unit included in the lifting device of the display apparatus according to the exemplary embodiment of FIG. 1;

FIG. 3 is a perspective view illustrating a rear surface of the display apparatus according to the exemplary embodiment of the present general inventive concept;

FIGS. 4A and 4B are perspective views illustrating wire connection methods of the lifting device of the display apparatus according to the exemplary embodiment of the present general inventive concept;

FIG. 5 is a side view illustrating the display apparatus fixed to a wall using the lifting device according to the exemplary embodiment of the present general inventive concept;

FIG. 6 is a perspective view illustrating a lifting device for a display apparatus according to another exemplary embodiment of the present general inventive concept;

FIG. 7 is a side view illustrating the display apparatus fixed to a wall using the lifting device according to the exemplary embodiment of FIG. 6; and

FIG. 8 is a front view illustrating a display apparatus fixed to a wall using a lifting device according to another exemplary embodiment of the present general inventive concept.

### DETAILED DESCRIPTION OF THE EMBODIMENTS

Reference will now be made in detail to exemplary embodiments of the present general inventive concept, examples of which are illustrated in the accompanying drawings, wherein like reference numerals refer to like elements throughout. The exemplary embodiments are described below to explain the present general inventive concept by referring to the figures.

First, a lifting device of a display apparatus according to a an exemplary embodiment of the present general inventive concept will be described with reference to the accompanying drawings.

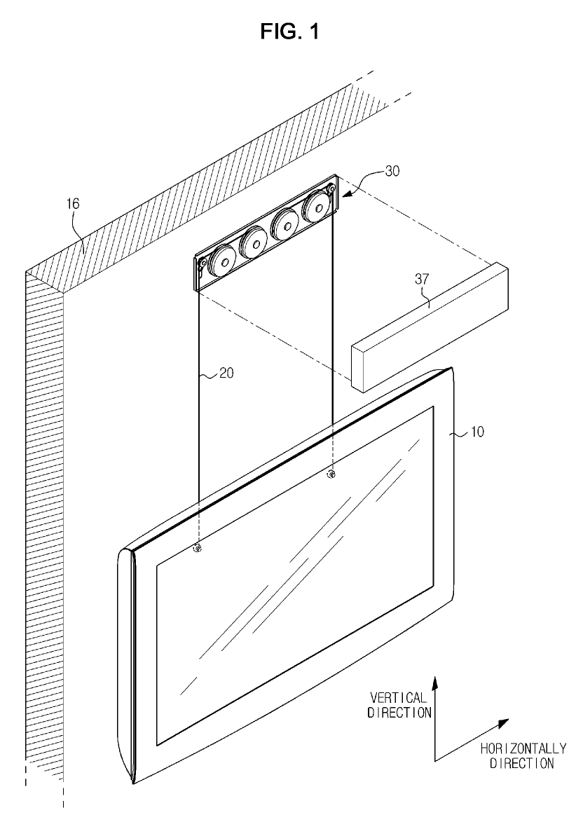

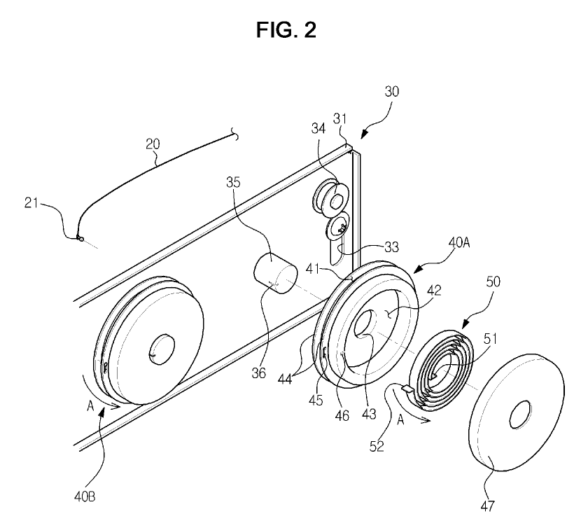

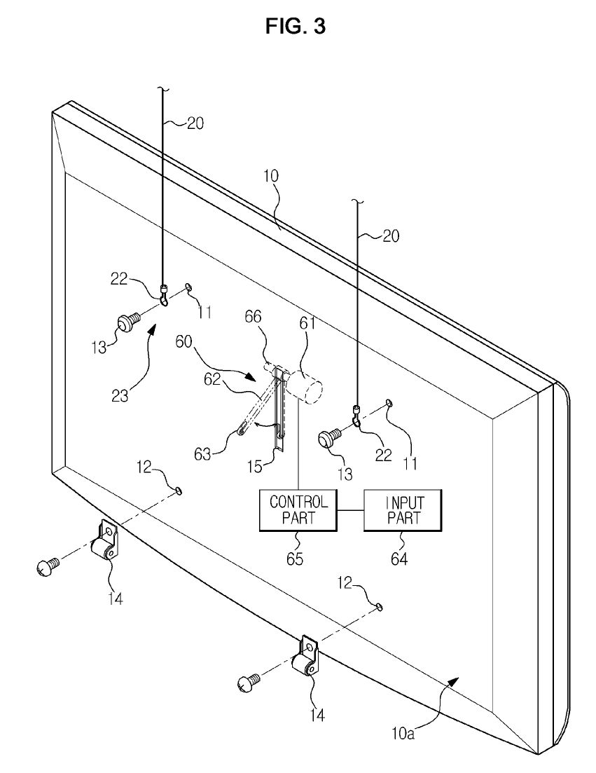

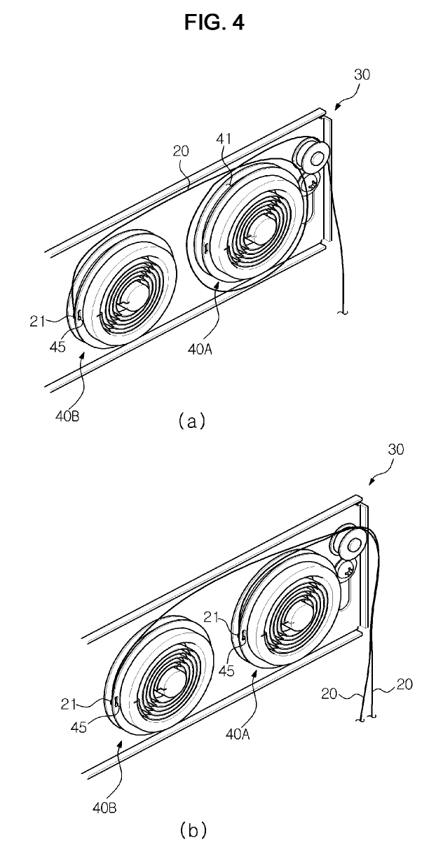

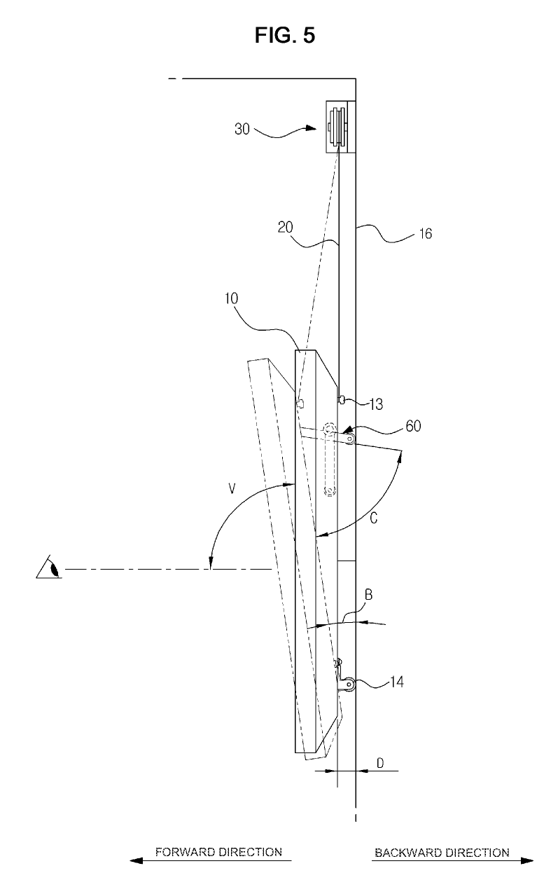

FIG. 1 is a perspective view illustrating an overall outer appearance of a lifting device of a display apparatus according to a first exemplary embodiment of the present general inventive concept, and FIG. 2 is an exploded perspective view illustrating components of a lifting unit included in the lifting device of FIG. 1. FIG. 3 is a perspective view illustrating a rear surface of the display apparatus of FIG. 1, and FIGS. 4A and 4B are perspective views illustrating wire connection methods of the lifting device of FIG. 1. Also, FIG. 5 is a side view illustrating the display apparatus fixed to a wall using the lifting device according to the first exemplary embodiment of the present general inventive concept.

The lifting device of the display apparatus according to the first exemplary embodiment of the present general inventive concept, as illustrated in FIGS. 1 through 3, includes at least one wire 20 connected to a display apparatus 10, a lifting unit 30 to move the wire 20 which may be connected to the display apparatus 10 in an upward or downward direction, while supporting a weight of the display apparatus 10, and a tilting unit 60 to adjust a viewing angle of the display apparatus 10.

The wire 20 is configured to connect the display apparatus 10 to the lifting unit 30, and may be made of metal so as to overcome a weight of the display apparatus 10. However, the present general inventive concept is not limited thereto. That is, the wire 20 may be made of any material capable of supporting a weight of the display apparatus 10.

Referring to FIG. 2, a first end 21 of the wire 20 may be connected to the lifting unit 30 and a second end 22 of the wire 20 may be fixed or coupled to a rear surface 10a of the display apparatus 10, as illustrated in FIG. 3. In exemplary embodiments, various other attachment methods may be used to couple the wire 20 to the display apparatus 10.

Referring to FIG. 3, the rear surface 10a of the display apparatus 10 may be formed with a plurality of holes 11 and 12. The plurality of holes 11 and 12 include a pair of first holes 11 (i.e., upper holes 11) for connection of the wire 20 and a pair of second holes (i.e., lower holes 12) to couple first wheels 14, which will be described hereinafter, to the rear surface 10a of the display apparatus 10.

The second end 22 of the wire 20 may be coupled to an upper hole 11. For this, the second end 22 of the wire 20 may include an attachment member 23, such as a ring form capable of being coupled to the rear surface of the display apparatus 10 by a coupling screw 13. That is, as the coupling screw 13 is screwed into the upper hole 11, the wire 20 may be firmly coupled to the display apparatus 10 via the attachment member 23.

When the wire 20 is fixed to the upper hole 11 which is formed in the rear surface 10a of the display apparatus 10, an upper portion of the display apparatus 10 may tilt in a forward direction (see FIG. 5). To prevent this tilting, the first wheels 14 may be coupled to the lower holes 12. In exemplary embodiments, the first wheels 14 maintain a constant distance D between the display apparatus 10 and the wall 16 in a vertical direction, to thereby prevent the display apparatus 10 from tilting in the forward direction.

Upon an upward/downward movement of the display apparatus 10, the first wheels 14 rotate while maintaining contact with the wall 16. This allows the display apparatus 10 to easily move in the upward or downward direction without causing damage to the rear surface 10a of the display apparatus 10.

In exemplary embodiments, the upper and lower holes 11 and 12 may be so-called VESA holes processed in the rear surface 10a of the display apparatus 10 to conform to Video Electronics Standards Association (VESA) wall-mount standards. With the use of the VESA holes, without requiring additional processing of the holes 11 and 12 on the display apparatus 10, the wire 20 and the first wheels 14 may be easily coupled to the display apparatus 10. However, the present general inventive concept is not limited thereto. That is, in exemplary embodiments, the wire 20 may be coupled to various other portions of the display apparatus 10, either directly or indirectly.

The lifting unit 30, as illustrated in FIG. 2, includes a fixing bracket 31 to fix the lifting unit 30 to the wall 16, at least one rotating drum 40; 40A and 40B may be rotatably fixed to the fixing bracket 31, on which the wire 20 is wound, a position retainer 50 to apply a force counter to a weight of the display apparatus 10 to the rotating drum 40 to maintain the display apparatus 10 at a fixed position, and a bearing 34 to guide the wire 20 to the rotating drum 40.

In exemplary embodiments, the fixing bracket 31 has a rectangular form. However, the present general inventive concept is not limited thereto. That is, in exemplary embodiments, the fixing bracket 31 may include various other shapes and sizes. Vertically-elongated screw holes 33 may be perforated on opposite side portions of the fixing bracket 31 to allow screws, which are used to fix the fixing bracket 31 to the wall 16, to be inserted through the screw holes 33.

The rotating drum 40 and the position retainer 50 may be received in the fixing bracket 31. For this, the fixing bracket 31 incorporates a rotating shaft 35, to which the rotating drum 40 may be rotatably coupled. The rotating shaft 35 may be provided in a same number as that of the rotating drum 40 and may be configured to protrude in the forward direction.

The rotating drum 40 may be defined, at an outer periphery thereof, with a rail 41, about which the wire 20 may be wound. Also, the rotating drum 40 may be internally defined with a receiving room 42 in which the position retainer 50 may be received. In turn, the receiving room 42 may be centrally perforated with a coupling hole 43 to correspond with the rotating shaft 35 to allow the rotating drum 40 to be rotatably coupled to the rotating shaft 35.

In exemplary embodiments, guides 44 to guide the wire 20 may protrude radially from the rail 41, and a fixing hole 45 may be formed in at least one of the guides 44 such that one end of the wire 20 may be fixed to the fixing hole 45.

The rotating drum 40 may be formed, at an inner periphery thereof which defines the receiving room 42, with a first fixing slit 46, to which one end of the position retainer 50 may be fixed.

The position retainer 50 may be an elastic member which includes a desired elasticity. In exemplary embodiments, the position retainer 50 may take the form of a spiral spring formed by rolling an elongated metal plate into a spiral shape. Both first and second ends 51 and 52 of the spiral spring are bent, such that the first end 51 may be fixed to a second fixing slit 36 formed at the rotating shaft 35 and the second end 52 may be fixed to the first fixing slit 46 formed on an inner periphery of the rotating drum 40.

With this arrangement, the spiral spring 50 received in the rotating drum 40 may press the rotating drum 40 in a spiral unwinding direction (indicated by the arrow A in FIG. 2) thereof. In this case, to obtain an elastic force counter to the weight of the display apparatus 10, the elasticity of the spiral spring 50 may be applied in a direction opposite to an application direction of the weight of the display apparatus 10. However, the present general inventive concept is not limited thereto.

In exemplary embodiments, the display apparatus 10 may have different weights according to a size thereof. The elasticity of the spiral spring 50 may be appropriately adjusted to effectively accommodate various different weights of the display apparatus 10. Specifically, in an exemplary embodiment, by changing a thickness, length, material, etc. of the spiral spring 50, it may be possible to design a spiral spring to include an elastic force counter to a desired load of the display apparatus 10.

In the present exemplary embodiment, although the position retainer 50 may be exemplified as the elastic member which exhibits an elastic force counter to the weight of the display apparatus 10, it will be clearly understood that the position retainer 50 may also be employed in any other configurations capable of exhibiting a force counter to the weight of the display apparatus 10.

In exemplary embodiments, although the elastic member in the form of the spiral spring 50 is described above, various other shapes and types of springs, such as a torsion spring, etc., may also be employed.

In addition, in the present exemplary embodiment, although a pair of rotating drums 40A and 40B to support the wire are described above, various amounts of the rotating drums may be provided according to a load of the display apparatus 10, and the like.

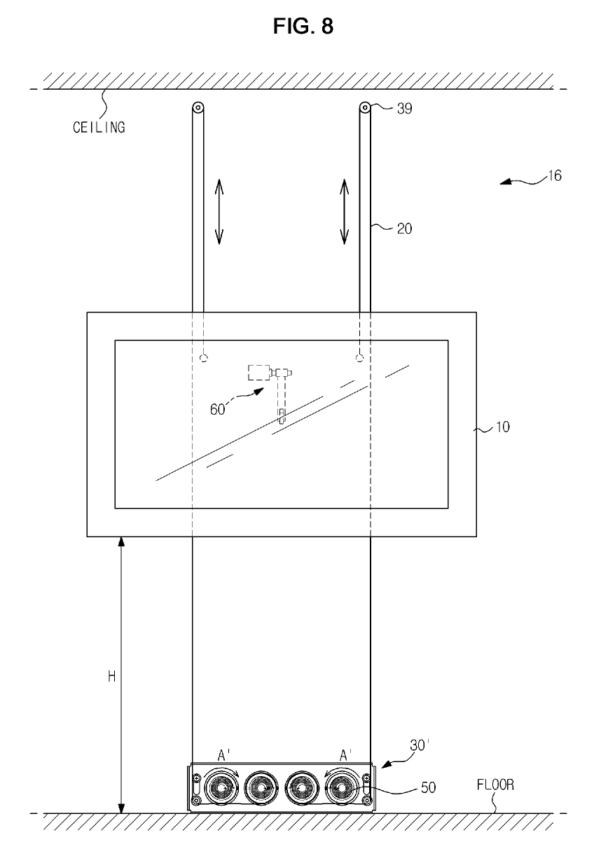

The display apparatus 10, which may be connected to the wire 20, may be maintained at a predetermined height H with respect to the floor via an elastic force of the spiral spring 50. (See FIG. 8).

In addition, a user may easily move the display apparatus 10 in an upward or downward direction. Specifically, the display apparatus 10 may be moved upward or downward as the wire 20 is wound on or unwound from the rotating drum 40. Once an external force applied by the user, for instance, is removed, the elasticity of the spiral spring 50 and the weight of the display apparatus may be in equilibrium, whereby the display apparatus 10 may be fixedly maintained at the predetermined height H (see FIG. 1).

The bearing 34 to guide the wire 20 may be provided on the fixing bracket 31 near each rotating drum 40 to assure an efficient movement of the wire 20 connected between the display apparatus 10 and the rotating drum 40. The bearing 34, in an exemplary embodiment, may be disposed at a position to allow the wire 20 to horizontally reciprocate between the bearing 34 and the rotating drum 40.

The lifting unit 30 may include a drum cover 47 to cover an open front surface of the rotating drum 40 in order to prevent the spiral spring 40 from being separated from the receiving room 42 in the rotating drum 40.

The lifting unit 30 may further include a bracket cover 37 (see FIG. 1) coupled with the fixing bracket 31 to shield, for example, the rotating drum 40 and the bearing 34 mounted on the fixing bracket 31.

Now, exemplary embodiments of methods used to connect the wire 20 to the lifting unit 30 will be described. In an exemplary embodiment, referring to FIG. 4A which illustrates the use of a single wire 20, the wire 20 may be first wound on the rail 41 of the first rotating drum 40A and thereafter, may be fixed to the fixing hole 45 of the second rotating drum 40B.

When fixing the wire 20 according to the present exemplary embodiment, the weight of the display apparatus 10 may be distributed to the first and second rotating drums 40A and 40B, to prevent an excessive load from being applied to the rotating drums 40A and 40B.

In alternative exemplary embodiments, as illustrated in FIG. 4B, the same number of wires 20 as the first and second rotating drums 40A and 40B may be provided such that the wires 20 may be fixed to the respective rotating drums 40A and 40B. The weight of the display apparatus 10 may be distributed through the use of the plurality of wires 20, and therefore, a thinner wire than that illustrated in FIG. 4A may be used. That is, a number of wires 20 used may correspond to a number of rotating drums 40 used.

The number and thickness of the wire may be variously changed according to the weight of the display apparatus 10 or a strength of the wire 20.

In exemplary embodiments, the lifting unit 30 and the display apparatus 10 may be connected to each other by using, for example, electrical wires or signal wires of the display apparatus 10, instead of the metal wire 20.

In exemplary embodiments, to be invisible from an outside, the wire 20 may be installed using a transparent tube, white tube, or the same or substantially similar color and pattern to the wall 16 to which the display apparatus 10 may be mounted.

The tilting unit 60 included in the present exemplary embodiment, as illustrated in FIGS. 3 and 5, includes a drive motor 61 mounted on the rear surface 10a of the display apparatus 10, an arm 62 having one end coupled to the drive motor 61 so as to be rotated about a rotating shaft 66 of the drive motor 61, and a second wheel 63 provided at an opposite end of the arm 62 to allow the arm 62 to smoothly move upward or downward on the wall 16.

A receiving recess 15 having a same or substantially similar shape as the arm 62 may be recessed in the rear surface 10a of the display apparatus 10 to receive the arm 62. The arm 62 may be received in the receiving recess 15 so as not to protrude from the rear surface 10a of the display apparatus 10.

In this case, note that the tilting unit 60 may be an independent unit and may be fixed or coupled to the rear surface 10a of the display apparatus 10. However, the present general inventive concept is not limited thereto. That is, in exemplary embodiments, the tilting unit 60 may be coupled to various other portions of the display apparatus 10.

The tilting unit 60 includes an input part 64 to apply signals to operate the drive motor 61, and a control part 65 to control the drive motor 61 based on the signals received from the input part 64. The input part 64 may include a wired or wireless transmitter and receiver (not illustrated) to transmit/receive signals from an external source (not illustrated).

The input part 64 may be provided in the display apparatus 10 or in a remote controller (not illustrated). The input part 64 may cause the arm 62 to be rotated by a rotation angle C of the arm 62 which corresponds to a tilting angle B of the display apparatus 10, or may apply On/Off signals of the drive motor 61 to the control part 65. In particular, a viewing angle V of the display apparatus 10 may be adjusted by adjusting a rotation angle C of the arm 62 with respect to the display apparatus 10. Thus, in exemplary embodiments, as the rotation angle C is increased, the tilting angle B may increase and the viewing angle V may decrease.

The control part 65 operates the drive motor 61 based on the signals applied from the input part 64, to thereby adjust the rotation angle C of the arm 62.

In an exemplary embodiment, if the user selects a tilting mode, under an operation of the control part 65, the arm 62 may be rotated by a rotation angle C of the arm 62 which corresponds to a predetermined tilting angle D recorded in the control part 65.

Specifically, the tilting mode may be classified, for example, into upper, medium, and lower levels according to the titling angle B. If the user selects any one of the upper, medium, and lower levels, the control part 65 controls the arm 62 such that the arm 62 may be rotated by the rotation angle C corresponding to the predetermined tilting angle B of the selected upper, medium, or lower level. That is, in exemplary embodiments, the upper, medium, and lower tilting mode levels may correspond to tilting angles B1, B2, and B3, respectively.

In the lifting device of the display apparatus 10 according to the first exemplary embodiment of the present general inventive concept, the wire 20 may be connected to the rotating drum 40 of the lifting unit 30 and in turn, the lifting unit 30 may be fixed to an upper position of the wall 16. Thereafter, the coupling screw 13 may be screwed to fix each wire 20 to the upper hole 11 in the rear surface of the display apparatus 10, and the first wheel 14 may be fixed or coupled to the lower hole 12 on the rear surface of the display apparatus 10, to thereby complete an assembly of the lifting device of the display apparatus 10.

The lifting device of the display apparatus 10 according to the present general inventive concept may achieve an improved space utility with a minimal distance between the display apparatus 10 and the wall 16, and may allow the user to easily move the display apparatus 10 in an upward or downward direction with less force. In addition, since a tilting unit 60 may be operated using a remote controller, or the like, a viewing angle V of the display apparatus 10 may be adjusted by using the remote controller or the like.

Next, a lifting device of a display apparatus 10 according to a another exemplary embodiment of the present general inventive concept will now be described.

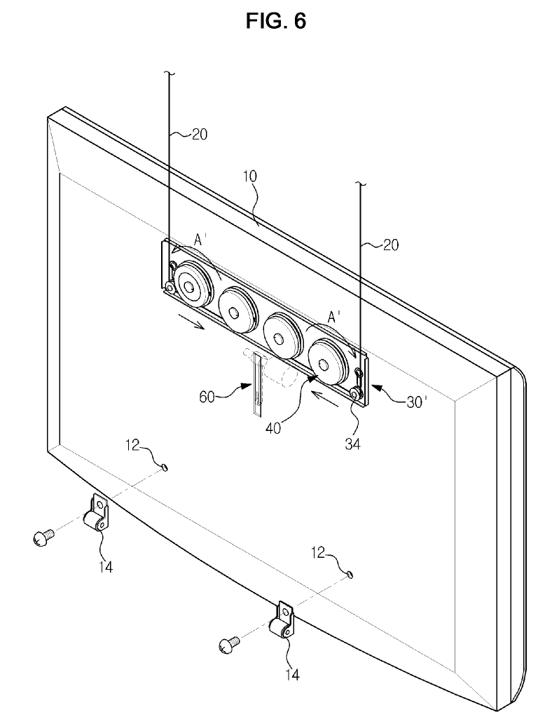

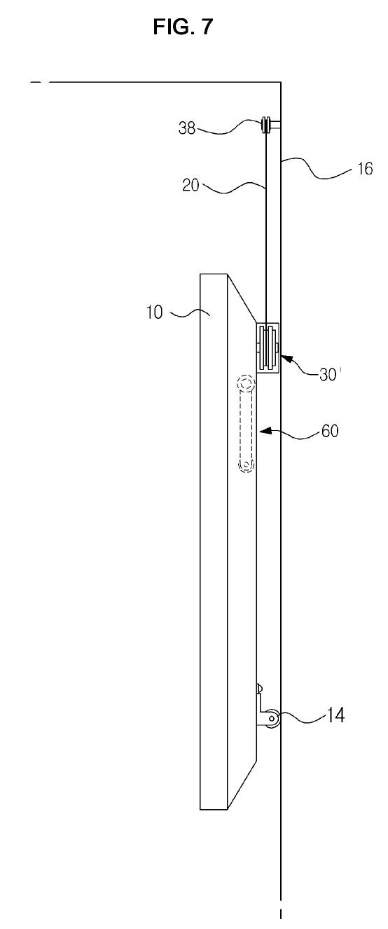

FIG. 6 is a perspective view illustrating a lifting device of a display apparatus according to another exemplary embodiment of the present general inventive concept, and FIG. 7 is a side view illustrating the display apparatus fixed to the wall using the lifting device according to the exemplary embodiment of FIG. 6.

A lifting unit 30′ included in the lifting device of the display apparatus 10 according to the exemplary embodiment of FIG. 6 includes substantially the same configuration as the lifting unit 30 included in the previous exemplary embodiment except for a position of the bearing and an arrangement of the elastic member. The lifting device may be fixed to the display apparatus 10 as the screws 13 are coupled into the attachment member 23 and the upper holes 11 in the rear surface of the display apparatus 10.

Hereinafter, the same elements as those of the exemplary embodiment of FIG. 1 are designated by the same reference numerals, and therefore a description thereof will be omitted.

The lifting device of the display apparatus 10 according to the exemplary embodiment of FIG. 6 includes the lifting unit 30′ mounted to the rear surface of the display apparatus 10 so as to move the display apparatus 10 in an upward or downward direction, the wire 20 having one end connected to the lifting unit 30′, a wire hanger 38 mounted to the wall so as to support an opposite end of the wire 20, and a tilting unit 60 to adjust a viewing angle of the display apparatus 10.

The first end 21 of the wire 20 may be coupled to the lifting unit 30′ in the same manner as the previous exemplary embodiment and the second end of the wire 20 may be firmly coupled to the wire hanger 38 which may be mounted to the wall 16.

The lifting unit 30′ may be fixed to the upper holes 11 using the screws 13. The bearing 34 used to guide the wire 20 may be arranged at a position to allow the wire 20, which connects the display apparatus 10 to the rotating drum 40, to move horizontally between the bearing 34 and the rotating drum 40.

In exemplary embodiments, the elastic member 50 may take the form of a spiral spring prepared by rolling an elongated metal plate in a spiral shape, and exhibits an elastic force counter to a weight of the display apparatus 10 in a spiral unwinding direction indicated by the arrow A′. By adjusting an elasticity of the elastic member 50 to correspond to the weight of the display apparatus 10, the display apparatus 10 may be maintained at a fixed position on the wall 16.

The lifting device for the display apparatus 10 according to the exemplary embodiment of FIG. 6 may realize movement in an upward/downward direction and a tilting operation of the display apparatus 10 similar to the first exemplary embodiment. Furthermore, since the lifting unit 30′ may be mounted on the rear surface 10a of the display apparatus 10 so as to be invisible from the outside, the lifting device may achieve an improvement in an external appearance.

Next, a lifting device for a display apparatus 10 according to a another exemplary embodiment of the present general inventive concept will now be described.

FIG. 8 is a front view illustrating a display apparatus 10 fixed to a wall 16 using a lifting device according to yet another exemplary embodiment of the present general invention.

Hereinafter, the same elements as those of the previous exemplary embodiments are designated by the same reference numerals, and therefore a description thereof will be omitted.

The lifting device for the display apparatus 10 according to the exemplary embodiment of FIG. 8, as illustrated in FIG. 8, includes a wire 20 connected to the display apparatus 10, a lifting unit 30′ which may be mounted to the wall 16 at a position near a floor to move the wire 20 which is connected to the display apparatus 10 in an upward or downward direction, a roller 39 mounted to the wall 16 at a position near a ceiling to guide the wire 20 while supporting a weight of the display apparatus 10, and the tilting unit 60 to adjust a viewing angle V of the display apparatus 10.

The first end 21 of the wire 20 may be coupled to the lifting unit 30′ in the same manner as the first exemplary embodiment and the second end 22 of the wire 20 may be connected to a rear surface 10a of the display apparatus 10.

The lifting unit 30′ has the same configuration as that of the second exemplary embodiment, and may be mounted to the wall 16 close to the floor.

In exemplary embodiments, the roller 39 may be rotatably mounted to the wall 16 close to the ceiling, so as to guide the wire 20 from the lifting unit 30′ to the display apparatus 10 while supporting the weight of the display apparatus 10.

The elastic member 50 may exhibit a force to rotate the rotating drum 40 in a direction A′, which is the spiral unwinding direction, and therefore, by adjusting the force to correspond to the weight of the display apparatus 10, the display apparatus 10 may be maintained at a fixed position on the wall 16.

The lifting device of the display apparatus 10 according to the third exemplary embodiment may realize an upward/downward movement and a tilting operation of the display apparatus 10 similar to the first exemplary embodiment. Furthermore, since the lifting unit 30′ may be mounted to the wall 16 close to the floor and may be hidden by furniture typically disposed on the floor so as to be invisible from the outside, the lifting device may achieve an improvement in an external appearance.

As apparent from the above description, the present general inventive concept provides a lifting device of a display apparatus, which may fix the display apparatus to a wall in an upwardly or downwardly movable manner with a compact configuration by using a wire connected to the display apparatus, such that the display apparatus may be vertically movable.

Also, by providing a lifting unit with a position retainer to exhibit a force counter to a load of the display apparatus, if a force applied by the user to move the display apparatus upward or downward is removed, the display apparatus may still be maintained at a predetermined position. This allows for an easy upward/downward movement of the display apparatus.

Also, according to the present general inventive concept, the lifting unit may be fixed to an upper or lower position of the wall or to any position on the rear surface of the display apparatus. This assures accommodation of various shapes of lifting devices.

Also, in addition to the upward/downward movement of the display apparatus, a tilting unit may be provided at the rear surface of the display apparatus to adjust a viewing angle of the display apparatus.

Furthermore, with a provision of a drive motor to drive the tilting unit, a manual operation of the tilting unit may be easily accomplished.

Although a few exemplary embodiments of the present general inventive concept have been illustrated and described, it would be appreciated by those skilled in the art that various changes may be made to these embodiments without departing from the principles and spirit of the general inventive concept, the scope of which is defined in the claims and their equivalents.

What is claimed is:

1. A lifting device of a display apparatus comprising:
at least one wire coupled to the display apparatus; and
a lifting unit coupled to the at least one wire to move the display apparatus in a first direction or a second direction using a first force on the display apparatus,
wherein the lifting unit includes a position retainer to apply a second force counter to a weight of the display apparatus to the at least one wire to maintain the display apparatus at a position, if the first force is removed.

2. The lifting device according to claim 1, wherein the at least one wire includes a first end coupled to the lifting unit and a second end coupled to a surface of the display apparatus.

3. The lifting device according to claim 2, wherein the lifting unit is configured to support the weight of the display apparatus and to guide the at least one wire.

4. The lifting device according to claim 2, further comprising:
a roller configured to support the weight of the display apparatus and to guide the at least one wire.

5. The lifting device according to claim 1, wherein:
the lifting unit is coupled to the display apparatus, and
the at least one wire includes a first end fixed to a position above the lifting unit and a second end coupled to the lifting unit.

6. The lifting device according to claim 1, wherein:
the lifting device further includes a first wheel coupled to a first portion of the display apparatus to allow a lower portion of the display apparatus to be supported on a wall.

7. The lifting device according to claim 1, wherein the lifting unit includes at least one rotating drum on which the at least one wire is wound.

8. The lifting device according to claim 1, wherein the position retainer includes an elastic member to counter the weight of the display apparatus.

9. The lifting device according to claim 7, wherein the lifting unit further includes a bearing provided between the rotating drum and the display apparatus to guide the at least one wire.

10. The lifting device according to claim 7, wherein the rotating drum defines a receiving room in which the position retainer is received and a rail about which the at least one wire is wound.

11. The lifting device according to claim 1, further comprising:
a tilting unit coupled to the display apparatus to tilt the display apparatus.

12. The lifting device according to claim 11, wherein the tilting unit includes a drive motor, an arm coupled to the drive motor so as to be rotated about a rotating shaft of the drive motor, and a second wheel provided at one end of the arm.

13. A lifting device of a display apparatus comprising:
at least one wire connected to the display apparatus;
a rotating drum to rotate to allow the at least one wire to be wound or unwound on or from the rotating drum according to a first or second directional movement of the display apparatus; and
a position retainer to apply a force counter to a weight of the display apparatus to the rotating drum so as to maintain the display apparatus at a position when no external force is applied.

14. The lifting device according to claim 13, wherein the position retainer includes a spiral spring provided in the rotating drum.

15. The lifting device according to claim 13, wherein a rotatable arm is provided at a surface of the display apparatus to tilt the display apparatus.

16. The lifting device according to claim 13, further comprising:
a fixing bracket to receive the rotating drum and the position retainer.

17. A lifting device of a display apparatus comprising:
at least one rotating drum mounted on one of the display apparatus and a fixed surface to which the display apparatus is attached;
a wire having one end connected to the at least one rotating drum and the other end connected to the other one of the display apparatus and the fixed surface to which the display apparatus is attached; and
a position retainer to apply a force counter to a weight of the display apparatus to the at least one rotating drum along an upward or downward movement direction of the display apparatus.

18. The lifting device according to claim 17, further comprising a rotating shaft to rotatably mount the at least one rotating drum on the one of the display apparatus and the fixed surface to which the display apparatus is attached.

19. The lifting device according to claim 18, wherein the position retainer includes a spiral spring having one end fixed to the at least one rotating drum and the other end fixed to the rotating shaft.

20. The lifting device according to claim 17, further comprising a fixing bracket to rotatably mount the at least one rotating drum on the fixed surface.

21. The lifting device according to claim 17, further comprising a fixing bracket to rotatably mount the at least one rotating drum on a rear surface of the display apparatus.

22. The lifting device according to claim 21, further comprising a roller mounted on the fixed surface to convert a movement direction of the wire.

23. The lifting device according to claim 17, wherein the at least one rotating drum includes a rail on or from which the wire is wound or unwound according to a first or second directional movement of the display apparatus.

24. The lifting device according to claim 17, further comprising a wheel coupled to a rear surface of the display apparatus to allow a lower portion of the display apparatus to be supported on the fixed surface.
